(19) United States
(12) Patent Application Publication
(10) Pub. No.: US 2013/0286356 A1
(43) Pub. Date: Oct. 31, 2013

(54) DISPLAY UNIT AND ILLUMINATION DEVICE

(71) Applicants: Kazuyuki Takahashi, Kanagawa (JP); Kazumasa Kaneda, Kanagawa (JP)

(72) Inventors: Kazuyuki Takahashi, Kanagawa (JP); Kazumasa Kaneda, Kanagawa (JP)

(21) Appl. No.: 13/863,078

(22) Filed: Apr. 15, 2013

(30) Foreign Application Priority Data
Apr. 26, 2012 (JP) 2012-101420

(51) Int. Cl. H04N 5/74; G02B 27/48; F21V 13/02; F21V 9/14

(52) U.S. Cl. CPC H04N 5/7416; F21V 9/14; G02B 27/48; F21V 13/02
USPC 353/20; 362/19

(57) ABSTRACT

An illumination device includes a laser light source, and a polarization control device configured to control a polarization state of laser light emitted thereon from the laser light source, and to output light having at least two different polarization states.

### CROSS REFERENCES TO RELATED APPLICATIONS

The present application claims priority to Japanese Patent Application JP 2012-101420 filed in the Japanese Patent Office on Apr. 26, 2012, the entire content of which is hereby incorporated by reference.

### BACKGROUND

The present disclosure relates to an illumination device emitting light including laser light, and a display unit displaying an image with use of such an illumination device.

A typical optical module, which is one of major components in a projector (a projection display unit), is configured of an illumination optical system (an illumination device or a light source device) including a light source, and a projection optical system including a light modulation device. In the field of such a projector, a small-sized (a palm-sized) lightweight portable projector called “microprojector” has recently become widespread. This microprojector uses an LED (Light-Emitting Diode) as the light source of the illumination device.

On the other hand, a laser is recently attracting an attention as a new light source of the illumination device. For example, a projector using a gas laser has been known as a projector using laser light of three primary colors of red (R), green (G), and blue (B). The projector using the laser as the light source has been proposed in, for example, Japanese Unexamined Patent Application Publication Nos. S55-65940 and H6-208089. The use of the laser as the light source allows a projector having a wide color reproduction range and low power consumption to be achieved.

### SUMMARY

When a diffusing surface is irradiated with coherent light such as laser light, a pattern having flecks is observed unlike with ordinary light. Such a pattern is referred to as a speckle pattern. The speckle pattern is produced by the interference of light scattered at points on the diffusing surface with a random phase relationship according to microscopic roughness on the diffusing surface.

In the projector using the above-described laser as a light source, such a speckle pattern (an interference pattern) is superimposed on a display image on a screen. As a result, human eyes perceive the speckle pattern as strong random noise, thereby resulting in a reduction in display image quality. Since production of the speckle pattern is a common issue when laser light having coherence is used as a light source, there is desired a proposal of a technique of reducing production of the speckle pattern (speckle noise).

It is desirable to provide an illumination device and a display unit capable of reducing production of an interference pattern.

In an embodiment, an illumination device includes a laser light source, and a polarization control device configured to control a polarization state of laser light emitted thereon from the laser light source, and to output light having at least two different polarization states.

In another embodiment, a display unit includes a laser light source, a light modulation device configured to modulate laser light emitted from the laser light source, and a polarization control device configured to control a polarization state of the modulated laser light emitted thereon, and to output light having at least two different polarization states.

In another embodiment, an illumination device includes a laser light source, and a polarization control region including a first sub-region having a first polarization state, and a second sub-region having a second polarization state.

In another embodiment, a display unit includes a laser light source, a light modulation device configured to modulate laser light emitted from the laser light source, and a polarization control region including a first sub-region having a first polarization state, and a second sub-region having a second polarization state.

According to another embodiment of the disclosure, there is provided an illumination device including: a light source section including a laser light source; and a polarization control device disposed on an optical path of laser light emitted from the laser light source, and controlling a polarization state of light incident thereon to emit outgoing light having two or more kinds of polarization states.

According to an embodiment of the disclosure, there is provided a display unit including: a light source section including a laser light source; a light modulation device modulating light emitted from the light source section, based on an image signal; and a polarization control device disposed on an optical path of laser light emitted from the laser light source, and controlling a polarization state of light incident thereon to emit outgoing light having two or more kinds of polarization states.

In the illumination device and the display unit according to the embodiments of the disclosure, when laser light emitted from the laser light source in the light source section enters the polarization control device, the polarization state of the incident light is controlled to emit outgoing light having two or more kinds of polarization states. Therefore, coherence in laser light is reduced through spatially superimposing such two or more kinds of polarized light.

In the illumination device and the display unit according to the embodiments of the disclosure, the polarization control device is disposed on the optical path of laser light, and emits outgoing light having two or more kinds of polarization states; therefore, a reduction in coherence in laser light is achievable. Accordingly, a reduction in production of an interference pattern caused by the laser light (an improvement in display image quality) is achievable.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

FIG. 1 is a diagram illustrating an entire configuration of a display unit according to a first embodiment of the disclosure.

FIG. 2 is a schematic plan view illustrating a specific configuration example of a planarization control device illustrated in FIG. 1.

FIG. 3 is a schematic view for describing a principle of producing an interference pattern.

FIG. 4 is another schematic view for describing the principle of producing the interference pattern.

FIG. 5 is a diagram illustrating an entire configuration of a display unit according to Comparative Example 1.

FIG. 6 is a schematic view for describing a function of the planarization control device illustrated in FIG. 2.

FIGS. 7A to 7C are other schematic views for describing the function of the polarization control device illustrated in FIG. 2.

FIG. 8 is a schematic view illustrating a configuration of an interference pattern measurement system according to Examples 1 and 2.

FIG. 9 is a schematic view illustrating a relationship between a projection region and a measurement region according to Examples 1 and 2.

FIGS. 10A to 10D are plot illustrating measurement results of the interference pattern according to Comparative Example 2 and Example 1.

FIG. 11A to 11D are plots illustrating measurement results of the interference pattern according to Comparative Example 2 and Example 2.

FIG. 12 is a diagram illustrating an entire configuration of a display unit according to a second embodiment.

FIGS. 13A to 13C are schematic plan views illustrating configuration examples of planarization control devices according to Modifications 1 to 3.

FIG. 14A and 14B are schematic views illustrating configuration examples of planarization control devices according to Modifications 4 and 5.

FIGS. 15A and 15B are schematic views illustrating arrangement examples of planarization control devices according to Modifications 6 and 7.

### DETAILED DESCRIPTION

Embodiments of the present application will be described below in detail with reference to the drawings.

1. First Embodiment (An example using a reflective liquid crystal device as a light modulation device)

2. Examples (Examples 1 and 2 of the first embodiment)

3. Second Embodiment (An example using a DMD as a light modulation device)

4. Modifications Common to First and Second Embodiments

Modifications 1 to 5 (Other configuration examples of the polarization control device)

Modifications 6 and 7 (Other arrangement examples of the polarization control device)

5. Other Modifications

### FIRST EMBODIMENT

[Configuration of Display Unit 3]

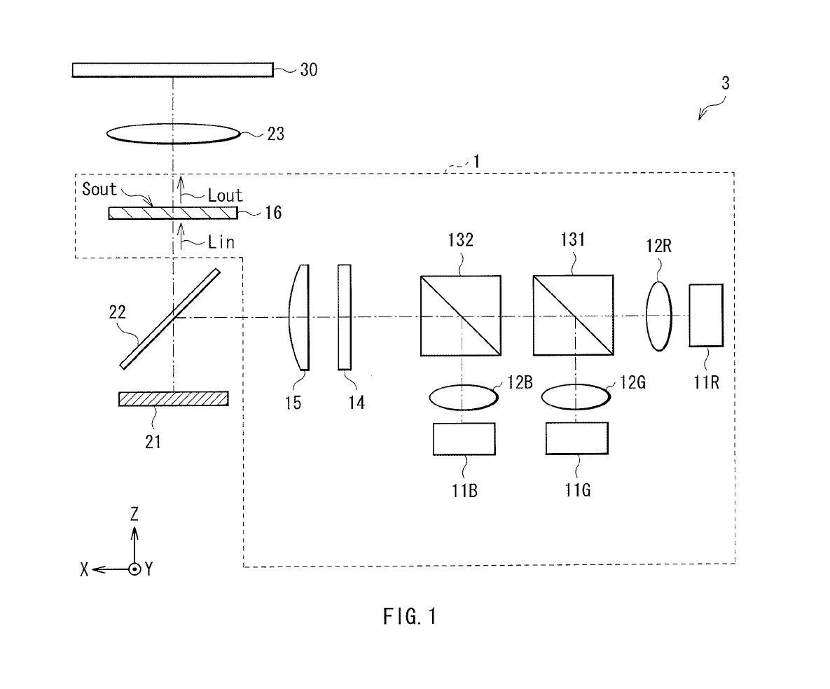

FIG. 1 illustrates an entire configuration of a display unit (a display unit 3) according to a first embodiment of the disclosure. The display unit 3 is a projection display unit which projects an image (image light) onto a screen 30 (a projection surface). The display unit 3 includes an illumination device (a light source device) 1, and an optical system (a display optical system) for displaying an image with use of illumination light (light source light) emitted from the illumination device 1. It is to be noted that an alternate long and short dashed line in FIG. 1 indicates an optical axis.

(Illumination Device 1)

The illumination device 1 includes a red laser 11R, a green laser 11G, a blue laser 11B, lenses 12R, 12G, and 12B, dichroic prisms 131 and 132, a fly-eye lens 14, a condenser lens 15, and a polarization control device 16.

The red laser 11R, the green laser 11G, and the blue laser 11B are three kinds of light sources emitting red laser light, green laser light, and blue laser light, respectively. A light source section is configured of these laser light sources, and each of these three kinds of light sources herein is a laser light source. Each of the red laser 11R, the green laser 11G, and the blue laser 11B is configured of, for example, a semiconductor laser or a solid laser. It is to be noted that, in the case where each of these laser light sources is a semiconductor laser, the red laser light, the green laser light, and the blue laser light have wavelengths λr, λg, and λb of about 600 nm to 700 nm, about 500 nm to 600 nm, and about 400 nm to 500 nm, respectively.

The lenses 12R and 12G are lenses (coupling lenses) for collimating the red laser light emitted from the red laser 11R and the green laser light emitted from the green laser 11G (into parallel light) to couple the collimated red light and the collimated green light, respectively, to the dichroic prism 131. Likewise, the lens 12B is a lens (a coupling lens) for collimating the blue laser light emitted from the blue laser 11B (into parallel light) to couple the collimated blue laser light to the dichroic prism 132. It is to be noted that each of these lenses 12R, 12G, and 12B herein collimates incident laser light (into parallel light), but this is not limitative, and the laser light may not be collimated (into parallel light) by the lenses 12R, 12G, and 12B. However, it is more preferable to collimate the laser light, because downsizing of a unit configuration is achievable.

The dichroic prism 131 selectively allows the red laser light incident thereon through the lens 12R to pass therethrough and selectively reflects the green laser light incident thereon through the lens 12G. The dichroic prism 132 selectively allows the red laser light and the green laser light emitted from the dichroic prism 131 to pass therethrough and selectively reflects the blue laser light incident thereon through the lens 12B. Thus, color synthesis (optical path synthesis) of the red laser light, the green laser light, and the blue laser light is performed.

The fly-eye lens 14 is an optical member (an integrator) configured of a plurality of lenses (unit cells) two-dimensionally arranged on a substrate. The fly-eye lens 14 spatially divides an incident light flux into a plurality of light fluxes according to the arrangement of these lenses to emit the light fluxes. Thus, light emitted from the fly-eye lens 14 is uniformized (an in-plane intensity distribution is uniformized). It is to be noted that the fly-eye lens 14 corresponds to a specific example of “uniformizing optical system” in the disclosure.

The condenser lens 15 is a lens for condensing the light emitted from the fly-eye lens 14 to efficiently guide illumination light to a reflective liquid crystal device 21 which will be described later.

The polarization control device (a polarization splitting device) 16 is disposed on an optical path of laser light, and is a flat-plate-like device controlling (converting and splitting) a polarization state of incident laser light (incident light Lin) to emit outgoing light Lout having two or more polarization states from an exit surface Sout thereof. More specifically, the polarization control device 16 is disposed on an optical path from the polarization beam splitter 22 toward the projection lens 23 (between the polarization beam splitter 22 which will be described later and the screen 30). The polarization control device 16 herein is disposed on an optical path between the polarizing beam splitter 22 and the projection lens 23. The polarization control device 16 is disposed on a side closer to the projection lens 23 of the polarization beam splitter 22 (in a stage following the polarization beam splitter 22) because of the following reason. When image light is produced with use of a combination of the polarizing beam splitter 22 and the reflective liquid crystal device 21, as will be described later, the polarization state is controlled even in these devices. Therefore, the polarization control device 16 is so disposed in the stage following the polarization splitter 22 as not to disturb a relationship of the polarization state.

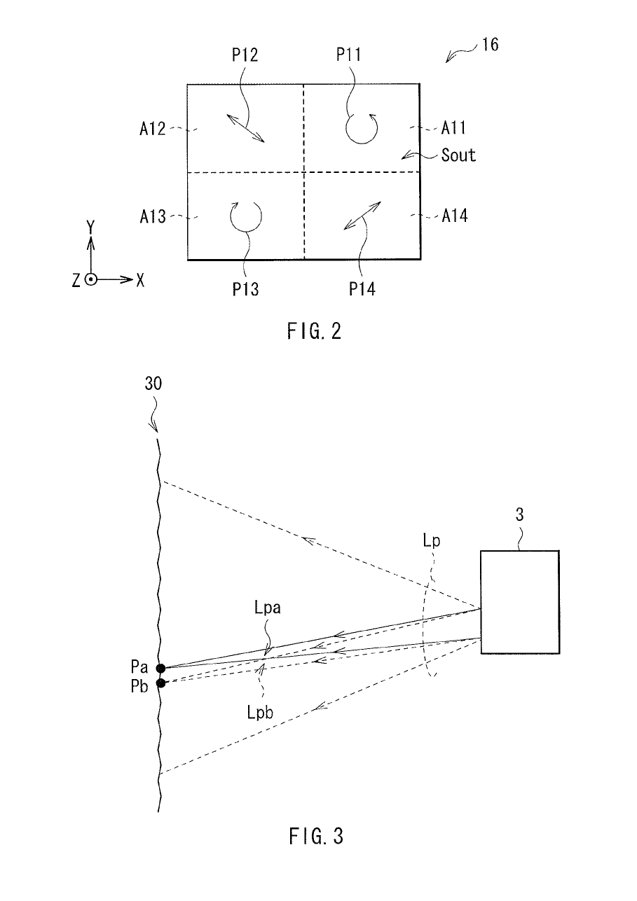

FIG. 2 schematically illustrates a planar configuration (X-Y planar configuration) example of the polarization control device 16 when viewed from the above-described exit surface Sout. In the polarization control device 16, the exit surface Sout (an X-Y plane) where the outgoing light Lout exits is divided into a plurality of sub-regions (herein, four sub-regions A11 to A14). Moreover, in this example, these four sub-regions A11 to A14 are two-dimensionally arranged (arranged in a matrix form) in the exit surface Sout. In other words, the sub-regions A11 to A14 are arranged in order of the sub-regions A12 and A11 and in order of the sub-regions A13 and A14 along a positive direction of an X axis, and in order of the sub-regions A13 and A12 and in order of the sub-regions A14 and A11 along a positive direction of a Y axis. The outgoing light Lout of the above-described two or more kinds of polarization states separately exits from these four sub-regions A11 to A14.

More specifically, for example, in the case where the incident light Lin incident on the polarization control device 16 is in a linear polarization state with a polarization axis along an X-axis direction, the outgoing light Lout of a counterclockwise circular polarization state (a polarization state P11) when viewed from the exit surface Sout exits from the sub-region A11. The outgoing light Lout of a linear polarization state (a polarization state P12) with a polarization axis along an upper-left oblique direction when viewed from the exit surface Sout exits from the sub-region A12. The outgoing light Lout of a clockwise circular polarization state (a polarization state P13) when viewed from the exit surface Sout exits from the sub-region A13. The outgoing light Lout of a linear polarization state (a polarization state P14) with a polarization axis along an upper-right oblique direction when viewed from the exit surface Sout exits from the sub-region A14. Thus, the outgoing light Lout from the polarization control device 16 preferably has both one or more kinds of linear polarization states (herein, two kinds of polarization states P12 and P14) and one or more kinds of circular polarization states (herein, two kinds of polarization states P11 and P13), because a function of reducing an interference pattern which will be described later is enhanced through mixing various polarization states in the outgoing light Lout in such a manner.

Such a polarization control device 16 is configured of, for example, different kinds of optical devices (devices having functions of a ¼ wave plate, a half-wave plate, and the like) disposed in the respective sub-regions A11 to A14. Examples of such optical devices include a polarizer film, a crystal (a birefringent material), a wire grid, and a polarizer.

(Display Optical System)

The above-described display optical system is configured of the polarizing beam splitter (PBS) 22, the reflective liquid crystal device 21 (a light modulation device), and the projection lens 23 (a projection optical system).

The polarizing beam splitter 22 is disposed on an optical path between the reflective liquid crystal device 21 and the projection lens 23, and is an optical member selectively allowing specific polarized light (for example, p-polarized light) to pass therethrough and selectively reflecting the other polarized light (for example, s-polarized light). Light (for example, s-polarized light) emitted from the illumination device 1 (more specifically, the condenser lens 15) is selectively reflected by the polarizing beam splitter 22 to enter the reflective liquid crystal device 21. Moreover, image light (for example, p-polarized light) emitted from the reflective liquid crystal device 21 selectively passes through the polarizing beam splitter 22 to enter the projection lens 23 (the polarization control device 16).

The reflective liquid crystal device 21 is a light modulation device reflecting light emitted from the illumination device 1 (the condenser lens 15) while modulating the light based on an image signal supplied from a display control section (not illustrated) to emit image light. At this time, the reflective liquid crystal device 21 reflects the light to allow light incident thereon and light exiting therefrom to have different polarization states (for example, s-polarization and p-polarization). The reflective liquid crystal device 21 is configured of, for example, a liquid crystal device such as an LCOS (Liquid Crystal On Silicon).

The projection lens 23 is a lens for projecting (enlarging and projecting), onto the screen 30, the image light modulated by the reflective liquid crystal device 21 and then incident thereon through the polarization control device 16 (the outgoing light Lout from the polarization control device 16).

[Functions and Effects of Display Unit 3]

(1. Display Operation)

In the display unit 3, first, the light (the laser light) emitted from the red laser 11R, the green laser 11G, and the blue laser 11B is collimated by the collimator lenses 12R, 12G, and 12B into parallel light, respectively. Next, the dichroic prisms 131 and 132 perform color synthesis (optical path synthesis) with the laser light (the red laser light, the green laser light, and the blue laser light) converted into the parallel light in the above-described manner. Each laser light subjected to the optical path synthesis enters the fly-eye lens 14, and the laser light is uniformized (the in-plane intensity distribution is uniformized) by the fly-eye lens 14. Then, the laser light is emitted as illumination light through the condenser lens 15. Thus, the illumination light is emitted from the illumination device 1.

Next, the illumination light is selectively reflected by the polarization beam splitter 22 to enter the reflective liquid crystal device 21. The reflective liquid crystal device 21 reflects the light incident thereon while modulating the light based on the image signal to emit the reflected and modulated light as image light. Since the reflective liquid crystal device 21 allows light incident thereon and light exiting therefrom to have different polarization states, the image light emitted from the reflective liquid crystal device 21 selectively passes through the polarization beam splitter 22 to enter the projection lens 23 through the polarization control device 16. Then, the incident light (the image light) is projected (enlarged and projected) onto the screen 30 by the projection lens 23.

At this time, the red laser 11 R, the green laser 11 G, and the blue laser 11B sequentially perform light emission (pulse light emission) in a time-divisional manner to emit laser light (red laser light, green laser light, and blue laser light, respectively). Then, based on image signals of respective color components (a red component, a green component, and a blue component), the reflective light crystal device 21 sequentially modulates laser light of corresponding colors in a time-divisional manner. Thus, a color image based on the image signals is displayed in the display unit 3.

(2. Function of Polarization Control Device 16)

Next, a function of the polarization control device 16 (the function of reducing an interference pattern which will be described later) will be described in detail below in comparison with a comparative example (Comparative Example 1).

(Principle of Producing Interference Pattern)

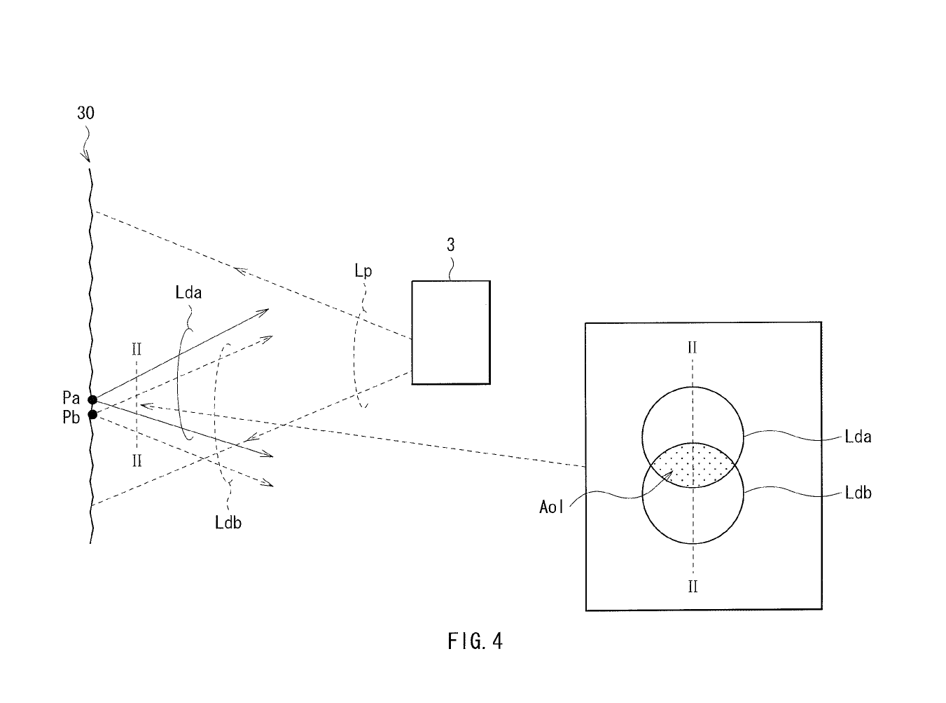

First, referring to FIGS. 3 and 4, a principle of producing an interference pattern (speckle noise) caused by laser light will be described below.

First, when a diffusing surface is irradiated with coherent light such as laser light, a pattern having flecks is observed unlike with ordinary light. Such a pattern is referred to as a speckle pattern (speckle noise). The speckle pattern is produced by the interference of light scattered at points on the diffusing surface with a random phase relationship according to microscopic roughness on the diffusing surface.

Now, referring to FIGS. 3 and 4, a principle of producing the speckle noise will be described in detail below. First, in this example, as illustrated in FIG. 3, projection light Lp which is enlarged and projected image light is emitted from the display unit 3 toward the screen 30. Then, two projection light fluxes Lpa and Lpb as some light fluxes of the projection light Lp are projected onto two adjacent projection points Pa and Pb, respectively. At this time, for example, as illustrated in FIG. 4, the projection light fluxes Lpa and Lpb are reflected from the projection points Pa and Pb, respectively, to produce diffused light fluxes Lda and Ldb. Even if the light fluxes are diffused, these diffused light fluxes Lda and Ldb maintain their polarization states in part; therefore, for example, as illustrated in a sectional view of the diffused light fluxes Lda and Ldb taken along a line II-II in FIG. 4, in an overlap region Aol where these diffused light fluxes Lda and Ldb overlap each other, the following occurs. In the case where the polarization states of the diffused light fluxes Lda and Ldb are the same as each other in the overlap region Aol, the diffused light fluxes Lda and Ldb interfere with each other. Then, when the degree of interference at this time is high, the overlap region Aol is observed as speckle noise.

Due to such a principle, in a projector using a laser light source such as the display unit 3, a speckle pattern (an interference pattern) is superimposed on a display image on the screen 30. As a result, human eyes perceive the speckle pattern as strong random noise, thereby resulting in a reduction in display image quality.

Therefore, in the projector using the laser light source, a technique of micro-vibrating the screen is considered to reduce production of such an interference pattern. In general, human eyes and brain hardly discriminate image flickers within a range from about 20 ms to about 50 ms. This means that the images within the time range are integrated and averaged in the human eyes. Hence, in this technique, a large number of independent speckle patterns are superimposed on the screen within the time range to thereby average the speckle noise to such an extent that the speckle noise does not annoy the human eyes. However, in this technique, it is necessary to micro-vibrate a large-scale screen itself, thereby resulting in upsizing of a unit configuration. In addition, an increase in power consumption, noise pollution, and the like are concerned.

### COMPARATIVE EXAMPLE 1

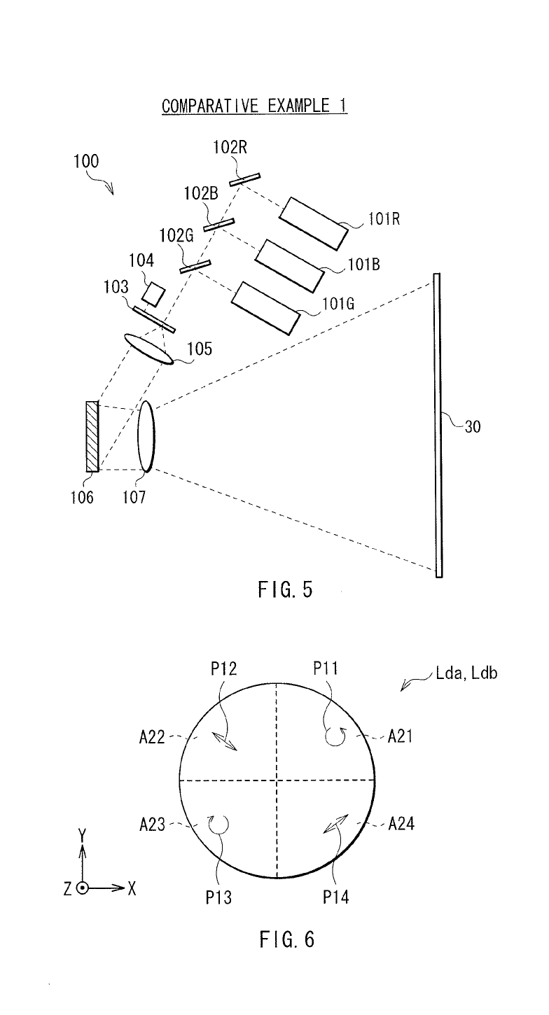

A display unit (a display unit 100) according to Comparative Example 1 illustrated in FIG. 5 reduces production of the interference pattern in the following manner. As with the display unit 3 according to the embodiment, the display unit 100 according to Comparative Example 1 is a projection display unit projecting image light onto the screen 30. The display unit 100 includes a red laser 101R, a green laser 101G, a blue laser 101B, dichroic mirrors 102R, 102G, and 102B, a diffusion device 103, a motor (a drive section) 104, a lens 105, a light modulation device 106, and a projection lens 107.

In the display unit 100, laser light of respective colors emitted from the red laser 101R, the green laser 101G, and the blue laser 101B is subjected to color synthesis (optical path synthesis) by the dichroic mirrors 102R, 102G, and 102B to enter the diffusion device 103. The incident light is diffused by the diffusion device 103, and then the diffused light is applied, as illumination light, to the light modulation device 106 by the lens 105. The light modulation device 106 reflects the illumination light while modulating the illumination light based on an image signal to emit the reflected and modulated light as image light. The image light is projected (enlarged and projected) onto the screen 30 by the projection lens 107. Thus, a color image based on the image signal is displayed in the display unit 100.

In the display unit 100, the diffusion device 103 is mechanically rotated by the motor 104 to change the position of the speckle pattern at high speed on the screen 30; therefore, a reduction in production of the interference pattern is achieved. However, in this technique, since light incident on the diffusion device 103 is diffused by the diffusion device 103, light use efficiency is reduced.

(Function of the embodiment)

On the other hand, the display unit 3 (the illumination device 1) according to the embodiment solves the above-described issue with use of the polarization control device 16 as below.

First, for example, as illustrated in FIG. 2, when laser light (red laser light, green laser light, and blue laser light) emitted from the laser light source (the red laser 11R, the green laser 11G, and the blue laser 11B) enters the polarization control device 16 as the incident light Lin, the polarization control device 16 performs the following polarization control. In the polarization control device 16, the polarization state of the incident light Lin is controlled, and the outgoing light Lout having two or more kinds of polarization states exits from the exit surface Sout. More specifically, in this example, the outgoing light Lout of the counterclockwise circular polarization state (the polarization state P11) exits from the sub-region A11, and the outgoing light Lout of the linear polarization state (the polarization state P12) with the polarization axis along the upper-left oblique direction exits from the sub-region A12. Moreover, the outgoing light Lout of the clockwise circular polarization state (the polarization state P13) exits from the sub-region A13, and the outgoing light Lout of the linear polarization state (the polarization state P14) with the polarization axis along the upper-right oblique direction exits from the sub-region A14.

Therefore, the diffused light fluxes Lda and Ldb described in the above-described example in FIGS. 3 and 4 pass through the polarization control device 16, and then are reflected from the projection points La and Lb on the screen 30, respectively, to each have, for example, a light flux section having polarization states illustrated in FIG. 6. In other words, the light flux sections of the diffused light fluxes Lda and Ldb each have the sub-regions A21 to A24 exhibiting four different polarization states in this example. More specifically, the sub-region A21 exhibits a counterclockwise circular polarization state (the polarization state P11), and the sub-region A22 exhibits a linear polarization state (the polarization state P12) with a polarization axis along an upper-left oblique direction. The sub-region A23 exhibits a clockwise circular polarization state (the polarization state P13), and the sub-regions A24 exhibits a linear polarization state (the polarization state P14) with a polarization axis along an upper-right oblique direction. In other words, in both the diffused light fluxes Lda and Ldb, the polarization states in the respective sub-regions A21 to A24 are the same as the polarization states of outgoing light Lout from the respective sub-regions A11 to A14 in the above-described polarization control device 16, respectively.

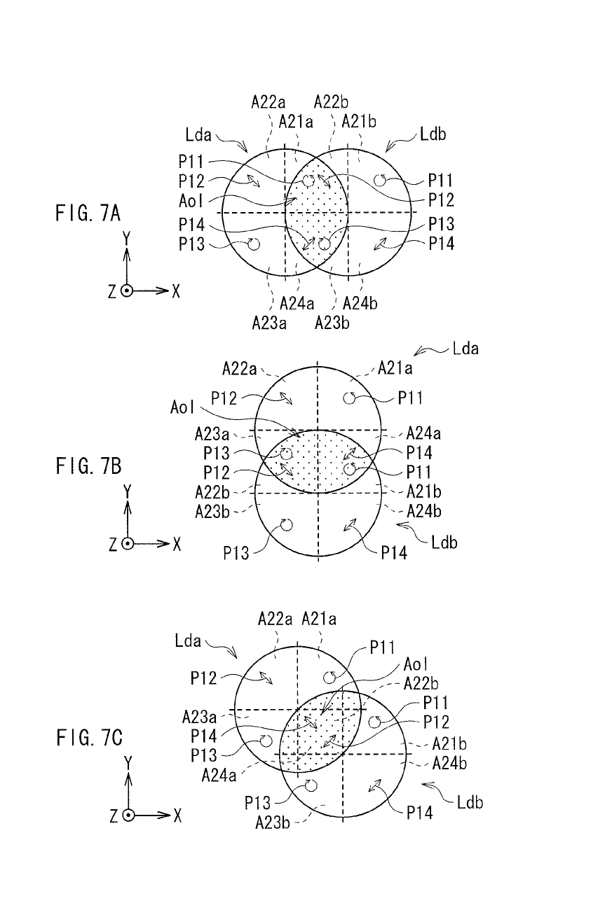

Then, the diffused light fluxes Lda and Ldb having such a light flux section spatially overlap each other in, for example, any one of states illustrated in FIGS. 7A to 7C. It is to be noted that, in examples in FIGS. 7A to 7C, for the sake of convenience, the above-described four sub-regions A21 to A24 of the diffused light flux Lda are described as sub-regions A21a to A24a, respectively, and the four sub-regions A21 to A24 of the diffused light flux Ldb are described as sub-regions A21b to A24b, respectively.

First, in the example in FIG. 7A, the diffused light fluxes Lda and Ldb are partially superimposed on each other along an X-axis direction. More specifically, the sub-region A21 a of the diffused light flux Lda and the sub-region A22b of the diffused light flux Ldb are partially superimposed on each other, and the sub-region A24a of the diffused light flux Lda and the sub-region A23b of the diffused light flux Ldb are partially superimposed on each other to produce the overlap region Aol. Thus, in the overlap region Aol, the polarization state P11 in the sub-region A21a and the polarization state P12 in the sub-region A22b overlap each other, and the polarization state P14 in the sub-region A24a and the polarization state P13 in the sub-region A23b overlap each other.

In the example in FIG. 7B, the diffused light fluxes Lda and Ldb are partially superimposed on each other along a Y-axis direction. More specifically, the sub-region A23a of the diffused light flux Lda and the sub-region A22b of the diffused light flux Ldb are partially superimposed on each other, and the sub-region A24a of the diffused light flux Lda and the sub-region A21b of the diffused light flux Ldb are partially superimposed on each other to produce the overlap region Aol. Thus, in the overlap region Aol, the polarization state P13 in the sub-region A23a and the polarization state P12 in the sub-region A22b overlap each other, and the polarization state P14 in the sub-region A24a and the polarization state P11 in the sub-region A21b overlap each other.

In the example in FIG. 7C, the diffused light fluxes Lda and Ldb are partially superimposed on each other along an oblique direction different from the X-axis direction and the Y-axis direction (an oblique direction in the X-Y plane). More specifically, in this example, mainly the sub-region A24a of the diffused light flux Lda and parts of the sub-regions A21b, A22b, and A23b of the diffused light flux Ldb are superimposed on each other. Moreover, the sub-region A22b of the diffused light flux Ldb and parts of the sub-regions A21a, A23a, and A24a of the diffused light flux Lda are superimposed on each other. Accordingly, such superimposition produces the overlap region Aol. Thus, in the overlap region Aol, the polarization state P14 in the sub-region A24a and the polarization states P11, P12, and P13 in the sub-regions A21b, A22b, and A23b overlap each other. Moreover, the polarization state P12 in the sub-region A22b and the polarization states P11, P13, and P14 in the sub-regions A21a, A23a, and A24a overlap each other.

Two or more kinds of polarization states (the polarization states P11 to P14) of the diffused light fluxes Lda and Ldb are spatially superimposed on each other in such a manner to reduce coherence in laser light, thereby suppressing production of the above-described interference pattern (speckle noise). It is to be noted that spatial overlapping of two diffused light fluxes Lda and Ldb of diffused light reflected from the screen 30 is described herein as an example; however, in actual diffused light, arbitrary diffused light fluxes spatially overlap one another to reduce coherence by a similar principle.

Moreover, in the embodiment, when production of the interference pattern is reduced with use of such a technique, unlike the technique in Comparative Example 1 or the like, a loss of laser light emitted from respective laser light sources does not occur. Therefore, an improvement in light use efficiency is achievable.

In addition, in the embodiment, a reduction in production of the interference pattern is achievable without using a dynamic technique such as micro-vibrating the screen 30, an optical device, or the like. Therefore, a unit configuration is simplified and downsized.

Thus, in the embodiment, since the polarization control device 16 is disposed on the optical path of laser light to emit the outgoing light Lout having two or more kinds of polarization states, a reduction in coherence in laser light is achievable.

Therefore, a reduction in production of the interference pattern caused by the laser light (an improvement in display image quality) is achievable.

### EXAMPLES

Next, specific examples (Examples 1 and 2) according to the first embodiment will be described below.

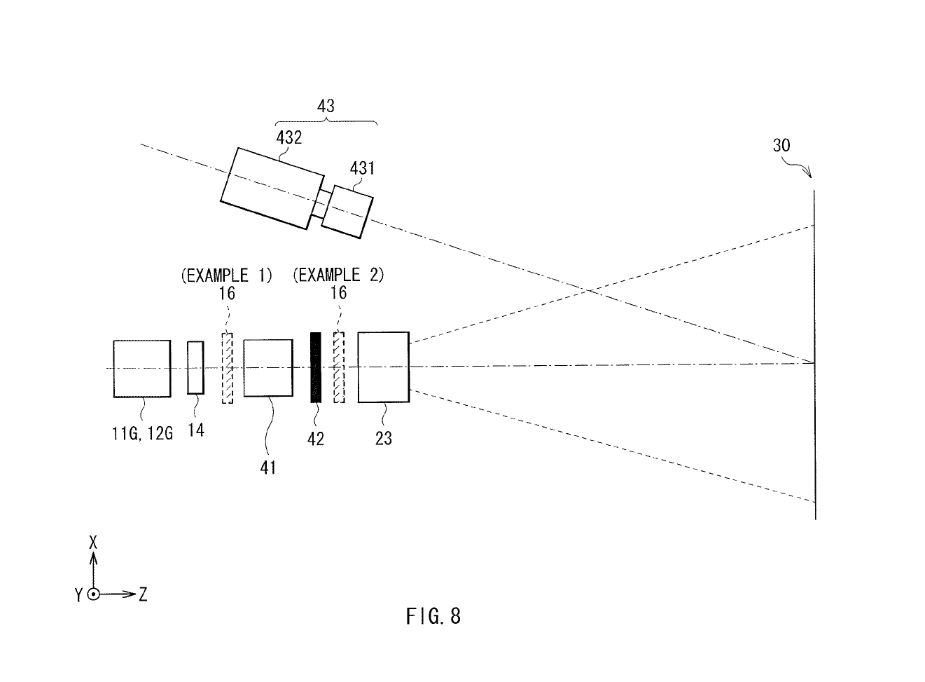

FIG. 8 schematically illustrates a configuration of an interference pattern measurement system according to Examples 1 and 2. The measurement system includes the green laser 11G, the lens 12G, the fly-eye lens 14, a telecentric optical system 41, a rectangular opening (aperture) 42 and the projection lens 23, the screen 30, and an image pickup device 43 having a CCD (Charge Coupled Device) 432 and an image pickup lens 431. In the measurement system, the polarization control device 16 described in the first embodiment is disposed on an optical path between the fly-eye lens 14 and the telecentric optical system 41 (Example 1) or an optical path between the opening 42 and the projection lens 23 (Example 2). It is to be noted that, in the measurement system, specific configurations of a light source unit configured of the green laser 11G and the lens 12G, the opening 42, the projection lens 23, a projection image projected onto the screen 30, and the image pickup device 43 are as below.

(Specific Configuration)

Light source unit: wavelength of green laser light Lg (parallel light)=532 nm, diameter φ of Lg=6 mm

Opening 42: aspect ratio=16:9

Projection lens 23: F-number=2.0, focal length=5 mm

Projection image: 25 inches

Image pickup device 43: resolution=1392 pixels (in the X-axis direction)×1040 pixels (in the Y-axis direction), size=⅔ inches, F-number=16, focal length=50 mm, object distance=933 mm

Moreover, a positional relationship between a projection region 51 in the projection image on the screen 30 and a measurement region (a shooting region) 52 by the image pickup device 43 is, for example, as illustrated in FIG. 9. More specifically, measurement conditions (luminance profile) for speckle contrast Cs (an indicator of a production rate of the interference pattern) determined by the following expression (1) are as below.

Cs=(σ/I) (1)

where σ is standard deviation of a luminance distribution (an intensity distribution) and I is an average value of the luminance distribution.

(Measurement Conditions)

Measurement value: luminance level

Measurement region 52: a central portion in both the X-axis direction and the Y-axis direction of the projection region 51

Measurement direction: two directions, i.e., the X-axis direction and the Y-axis direction in the measurement region 52

(Measurement Results of Interference Pattern)

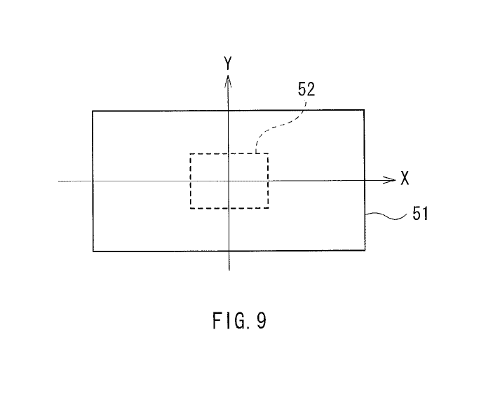

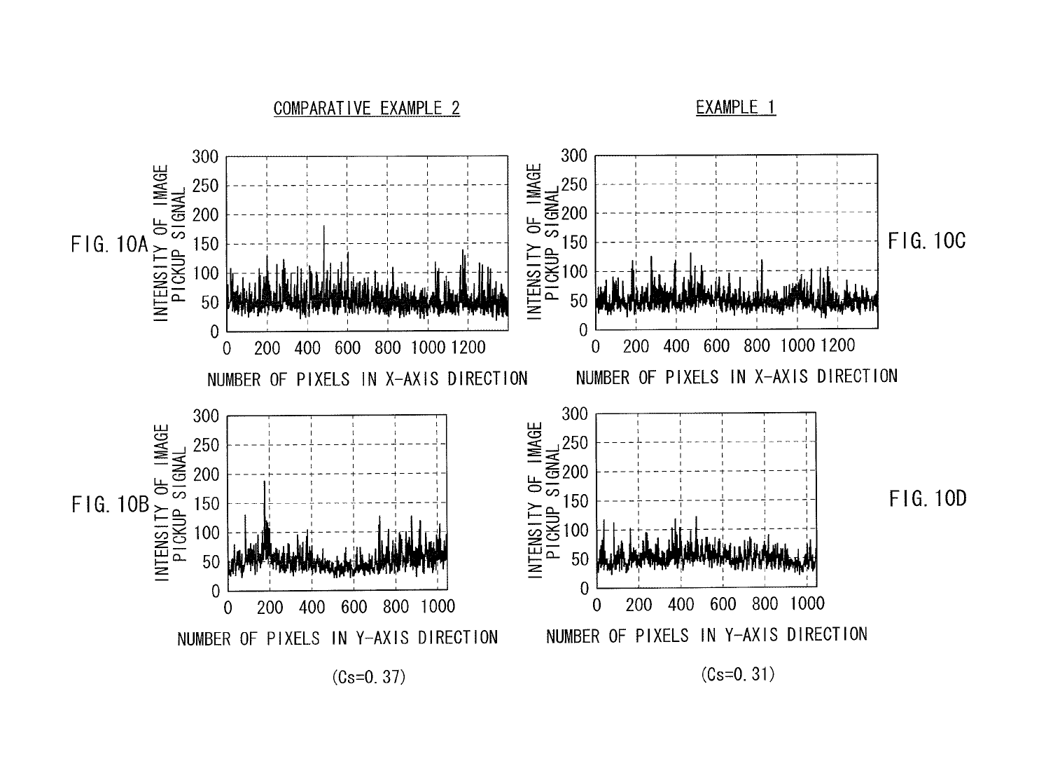

FIGS. 10A and 10B illustrate measurement results of the interference pattern in Comparative Example 2 (an example in which the measurement system illustrated in FIG. 8 is not provided with the polarization control device 16). On the other hand, FIGS. 10C and 10D illustrate measurement results of the interference pattern in the above-described Example 1. More specifically, FIGS. 10A and 10C illustrate measurement results in the case where the measurement direction was the X-axis direction, and illustrate a relationship between the number of pixels (the number of image pickup pixels) in the X-axis direction and intensity of an image pickup signal. On the other hand, FIGS. 10B and 10D illustrate measurement results in the case where the measurement direction was the Y-axis direction, and illustrate a relationship between the number of pixels (the number of image pickup pixels) in the Y-axis direction and intensity of the image pickup signal. It was clear from FIGS. 10A to 10D that, compared to Comparative Example 2 (with speckle contrast Cs=0.37), in Example 1 (with speckle contrast Cs=0.31), the production rate of the interference pattern was reduced, and display image quality was improved.

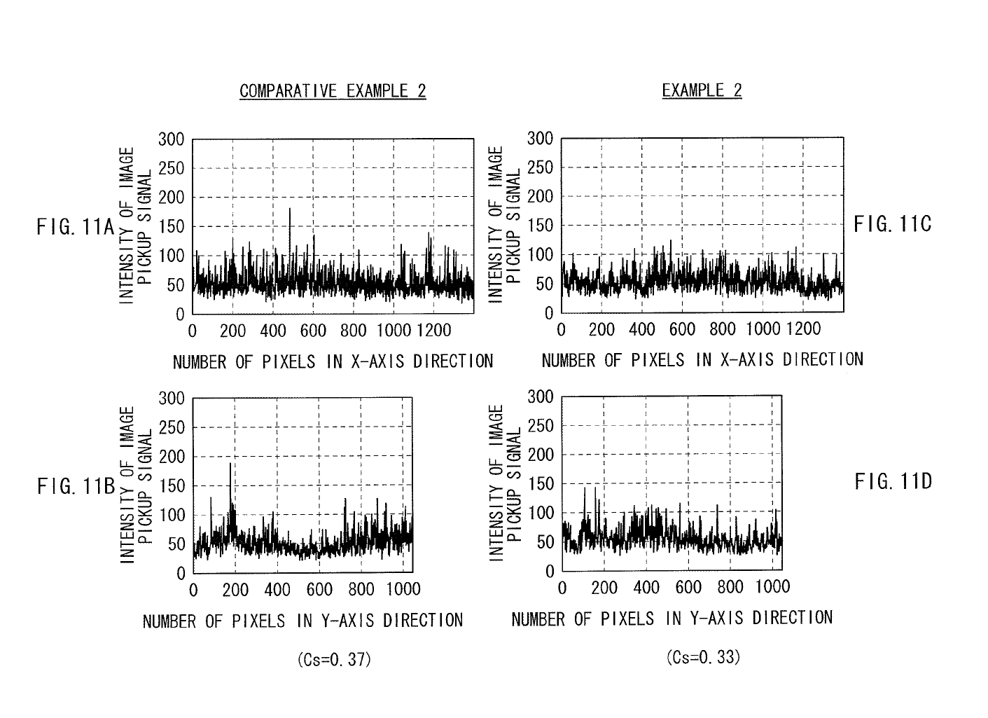

Moreover, FIGS. 11A and 11B illustrate measurement results of the interference pattern in the above-described Comparative Example 2, and FIGS. 11C and 11D illustrate measurement results of the interference pattern in the above-described Example 2. More specifically, FIGS. 11A and 11C illustrate measurement results in the case where the measurement direction was the X-axis direction, and FIGS. 11B and 11D illustrate measurement results in the case where the measurement direction was the Y-axis direction. It was clear from FIGS. 11A to 11D that, compared to Comparative Example 2 (with speckle contrast Cs=0.37), in Example 2 (with speckle contrast Cs=0.33), the production rate of the interference pattern was reduced, and display image quality was improved.

### SECOND EMBODIMENT

Next, a second embodiment of the disclosure will be described below. While a liquid crystal device (the reflective liquid crystal device 21) is used as a light modulation device in the display unit 3 according to the first embodiment, in a display unit according to the second embodiment, as will be described below, a digital mirror device (DMD) is used as a light modulation device. It is to be noted that like components are denoted by like numerals as of the first embodiment and will not be further described.

[Configuration of Display Unit 3A]

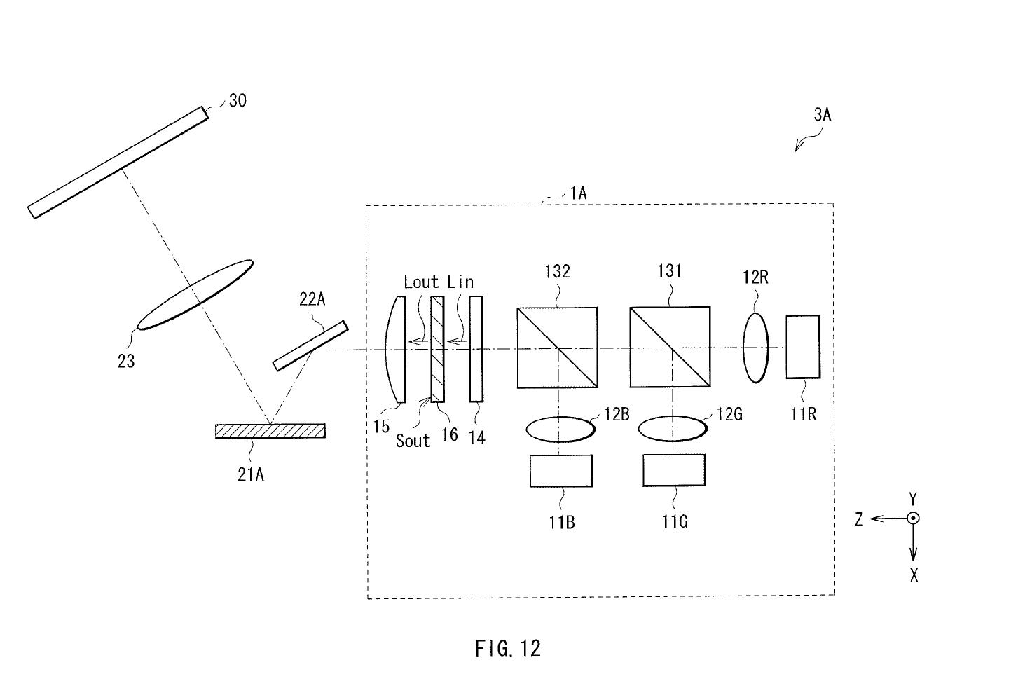

FIG. 12 illustrates an entire configuration of the display unit (display unit 3A) according to the second embodiment. The display unit 3A is also a projection display unit, and includes an illumination device (a light source device) 1A and an optical system (a display optical system) for displaying an image with use of illumination light (light source light) emitted from the illumination device 1A. It is to be noted that an alternate long and short dashed line in FIG. 12 indicates an optical axis.

(Illumination Device 1A)

As with the illumination device 1 according to the first embodiment, the illumination device 1A includes the red laser 11R, the green laser 11G, the blue laser 11B, the lenses 12R, 12G, and 12B, the dichroic prisms 131 and 132, the fly-eye lens 14, the condenser lens 15, and the polarization control device 16.

However, in the illumination device 1A, the position of the polarization control device 16 is different from that in the illumination device 1. More specifically, the polarization control device 16 is disposed on an optical path in a stage following the fly-eye lens 14 (on a side closer to a DMD 21A which will be described later of the fly-eye lens 14; between the fly-eye lens 14 and the screen 30). The polarization control device 16 herein is disposed on an optical path between the fly-eye lens 14 and the condenser lens 15.

(Display Optical System)

The display optical system according to the embodiment is configured of a mirror plate 22A, the DMD 21A (a light modulation device), and the projection lens 23. In other words, the display optical system according to the embodiment is different from the display optical system according to the first embodiment in that the mirror plate 22A and the DMD 21A are included instead of the polarizing beam splitter 22 and the reflective liquid crystal device 21, respectively.

The mirror plate 22A is an optical reflective device reflecting light (illumination light) emitted from the illumination device 1A (the condenser lens 15) to allow the light to enter the DMD 21A.

The DMD 21A is a light modulation device reflecting the illumination light reflected from the mirror plate 22A to be incident thereon while modulating the illumination light based on an image signal supplied from a display control section (not illustrated) to emit image light. At this time, unlike the reflective liquid crystal device 21, in the DMD 21A, a polarization state of incident light is the same as a polarization state of exiting light.

[Functions and Effects of Display Unit 3A]

Basically, the display unit 3A (the illumination device 1A) according to the embodiment is also allowed to obtain similar effects by functions similar to those in the display unit 3 (the illumination device 1) according to the first embodiment. In other words, since the polarization control device 16 is disposed on the optical path of laser light, a reduction in coherence in laser light is achievable, and a reduction in production of the interference pattern caused by laser light (an improvement in display image quality) is achievable.

In particular, in the embodiment, since the DMD 21A is used as the light modulation device, unlike the first embodiment in which the reflective liquid crystal device 21 is used as the light modulation device, the polarization control device 16 may be disposed not only in the stage following the DMD 21A (on a side closer to the screen 30 of the DMD 21A) but also in a state preceding the DMD 21A (on a side closer to the laser light source of the DMD 21A), because, as described above, unlike the reflective liquid crystal device 21, in the DMD 21A, the polarization state of incident light is the same as the polarization state of exiting light.

### MODIFICATIONS

Next, modifications (Modifications 1 to 7) common to the first and second embodiments will be described below. It is to be noted that like components are denoted by like numerals as of the first and second embodiments and will not be further described.

### Modifications 1 to 5

First, Modifications 1 to 5 will be described below. In Modifications 1 to 5, other configuration examples of the “polarization control device” in the disclosure will be described below.

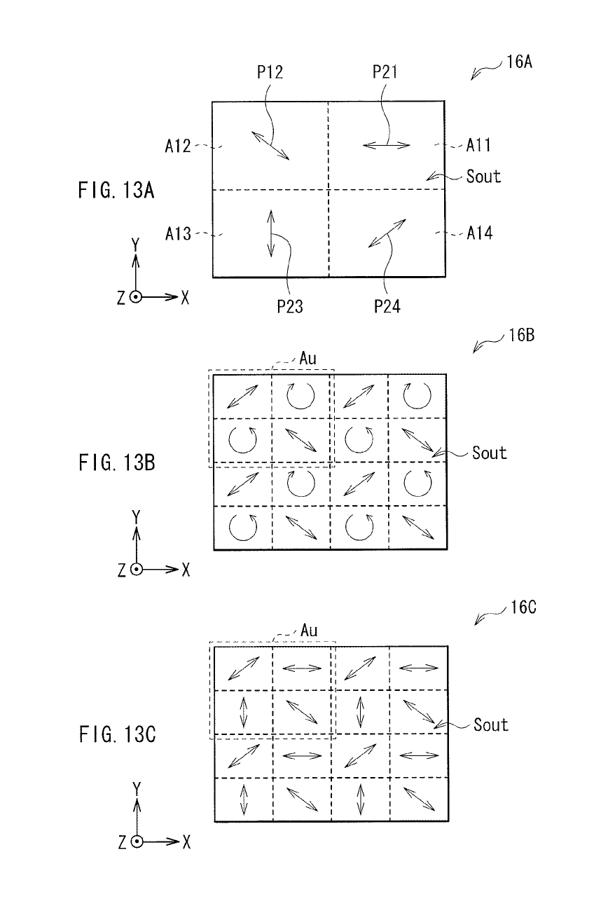

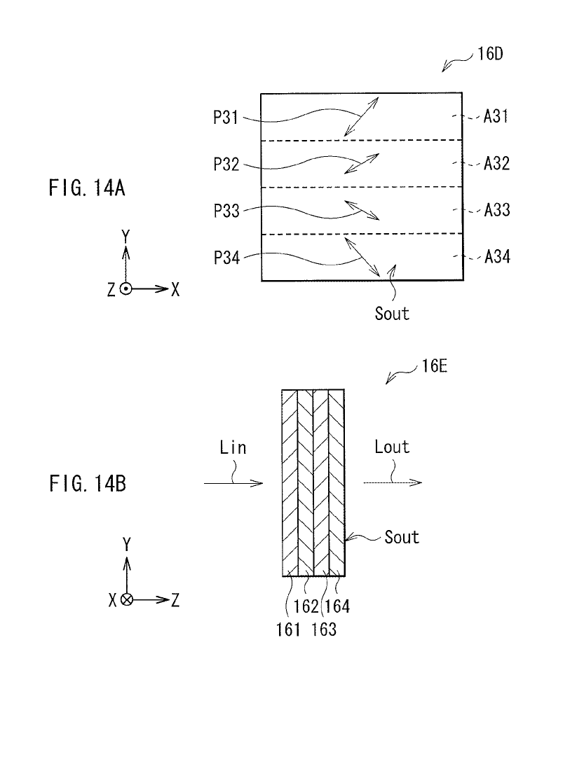

FIGS. 13A to 13C schematically illustrate planar configuration (X-Y planar configuration) examples, when viewed from the exit surface Sout, of planarization control devices (planarization control devices 16A to 16C) according to Modifications 1 to 3, respectively. Moreover, FIG. 14A schematically illustrates a planar configuration (X-Y planar configuration) example, when viewed from the exit surface Sout, of a planarization control device (a planarization control device 16D) according to Modification 4. FIG. 14B schematically illustrates a sectional configuration (Y-Z planar configuration) example of a polarization control device (a polarization control device 16E) according to Modification 5.

In the polarization control device 16A according to Modification 1 illustrated in FIG. 13A, as with the polarization control device 16, the exit surface Sout (the X-Y plane) where the outgoing light Lout exits is divided into a plurality of sub-regions (herein, four sub-regions A11 to A14), and the sub-regions A11 to A14 are two-dimensionally arranged (arranged in a matrix form). Then, the outgoing light Lout of the above-described two or more kinds of polarization states separately exits from these four sub-regions A11 to A14. More specifically, the outgoing light Lout of a linear polarization state (a polarization state P21) with a polarization axis along the X-axis direction exits from the sub-region A11. The outgoing light Lout of a linear polarization state (a polarization state P22) with a polarization axis along an upper-left oblique direction when viewed from the exit surface Sout exits from the sub-region A12. The outgoing light Lout of a linear polarization state (a polarization state P23) with a polarization axis along the Y-axis direction exits from the sub-region A13. The outgoing light Lout of a linear polarization state (a polarization state P24) with a polarization axis along an upper-right oblique direction when viewed from the exit surface Sout exits from the sub-region A14.

Thus, the outgoing light Lout from the polarization control device 16A has one or more kinds of linear polarization states (herein, four kinds of polarization states P21 to P24) only. In other words, unlike the polarization control device 16, the outgoing light Lout may not have both the linear polarization state and the circular polarization state. However, the outgoing light Lout preferably has both the linear polarization state and the circular polarization state because of the above-described reason.

In the polarization control devices 16B and 16C according to Modifications 2 and 3 illustrated FIGS. 13B and 13C, respectively, the exit surface Sout (the X-Y plane) is divided into a plurality of unit regions (herein, four unit regions Au), and these unit regions Au are two-dimensionally arranged (arranged in a matrix form). Then, as with the polarization control devices 16 and 16B, each of the unit regions Au includes a plurality of sub-regions (herein, four sub-regions) where the outgoing light Lout of different polarization states exits. Moreover, as with the polarization control device 16, in the polarization control device 16B, the outgoing light Lout having both linear polarization states and circular polarization states exits from each of the unit regions Au. On the other hand, as with the polarization control device 16B, in the polarization control device 16C, the outgoing light Lout having only the linear polarization states exits from each of the unit regions Au.

Thus, the exit surface Sout may include a plurality of unit regions Au each including a plurality of sub-regions, thereby including a large number of sub-regions (herein, 16 sub-regions). It is to be noted that the number of the unit regions Au and the number of the sub-regions are not specifically limited, as long as they are two or more.

In the polarization control device 16D according to Modification 4 illustrated in FIG. 14A, as with the polarization control device 16, the exit surface Sout (the X-Y plane) is divided into a plurality of sub-regions (herein, four sub-regions A31 to A34). However, in the polarization control device 16D, unlike the polarization control device 16, the four sub-region A31 to A34 are one-dimensionally arranged (herein, one-dimensionally arranged along the Y-axis direction) in the exit surface Sout. Then, the outgoing light Lout of two or more kinds of polarization states separately exits from these four sub-regions A31 to A34. More specifically, in this example, the outgoing light Lout of linear polarization states (polarization states P31 to P34) with polarization axes along directions different from one another exits from these sub-regions A31 to A34, respectively.

Thus, the technique of arranging a plurality of sub-regions in the exit surface Sout of the polarization control device is not specifically limited, and the plurality of sub-regions may be arranged in a radial form or a ring form in addition to the above-described one-dimensional arrangement and the above-described two-dimensional arrangement (matrix arrangement).

Moreover, the polarization control device 16E according to Modification 5 illustrated in FIG. 14 is configured of a plurality of kinds of optical devices (herein, four kinds of optical device 161 to 164) laminated along an optical path (a thickness direction of the device) of laser light (incident light Lin and outgoing light Lout). Then, the outgoing light Lout of two or more kinds of polarization states separately exits from these four kinds of optical devices 161 to 164. It is to be noted that each of these optical devices 161 to 164 is configured of, for example, a device similar to the optical device configuring each of the above-described sub-regions.

Thus, unlike the polarization control devices 16 and 16A to 16D, without arranging a plurality of sub-regions spatially divided in the exit surface Sout, a plurality of kinds of optical devices may be laminated along the optical path (the thickness direction of the device) of laser light to produce two or more kinds of polarization states.

### Modifications 6 and 7

Next, Modifications 6 and 7 will be described below. In Modifications 6 and 7, other arrangement examples (preferable arrangement examples) of the “polarization control device” in the disclosure will be described below.

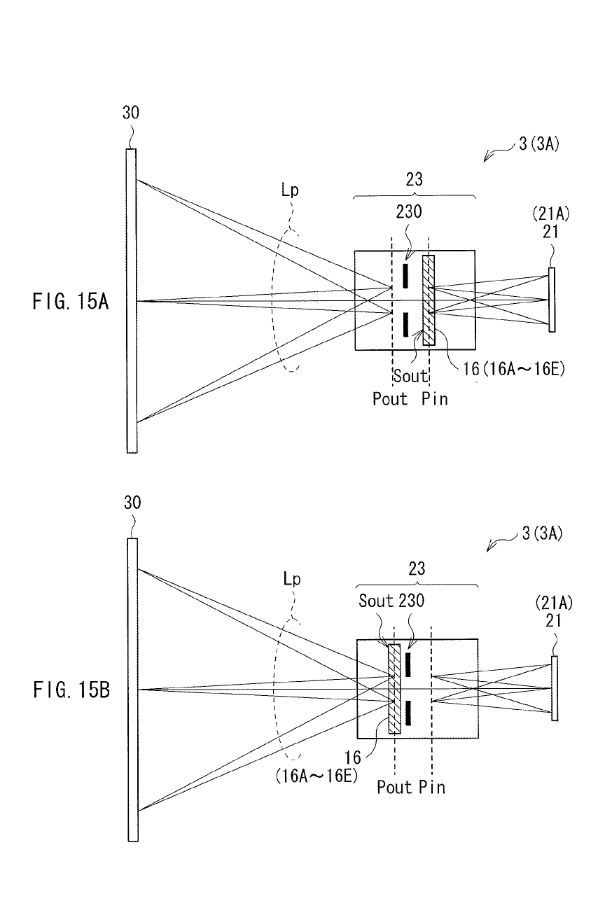

FIGS. 15A and 15B schematically illustrate arrangement examples of the polarization control device 16 (or any one of the polarization control devices 16A to 16E) according to Modifications 6 and 7. In the display unit 3 (or the display unit 3A) according to Modifications 6 and 7, an aperture 230 having an opening is disposed in the projection lens 23. Then, the polarization control device 16 (or any one of the polarization control devices 16A to 16E) is disposed at (or in proximity to) the position of the aperture 230. For example, in Modifications 6 and 7, the polarization control device 16 (or any one of the polarization control devices 16A to 16E) is disposed at (or in proximity to) an entrance pupil position Pin or an exit pupil position Pout in the projection lens 23.

More specifically, in Modification 6 illustrated in FIG. 15A, the polarization control device 16 (or any one of the polarization control devices 16A to 16E) is disposed at the entrance pupil position Pin in the projection lens 23. In Modification 7 illustrated in FIG. 15B, the polarization control device 16 (any one of the polarization control devices 16A to 16E) is disposed at the exit pupil position Pout in the projection lens 23.

Thus, the polarization control device 16 (or any one of the polarization control devices 16A to 16E) is preferably disposed at or in proximity to a pupil position (physically, an aperture position), where all light fluxes forming a projection image (projection light Lp) commonly intersect, of the projection lens 23. Accordingly, a function of reducing coherence of a plurality of light fluxes is most effectively fulfilled, and a further reduction in production of the interference pattern (a further improvement in display image quality) is achievable.

### OTHER MODIFICATIONS

Although the technology of the disclosure is described referring to the embodiments, the examples, and the modifications, the technology is not limited thereto, and may be variously modified.

For example, the configuration examples and the arrangement examples of the polarization control device are not limited to those described in the above embodiments and the like, and the polarization control device may have any other configuration example or any other arrangement example.

Moreover, in the above-described embodiments and the like, the case where a plurality of kinds (red, green, and blue) of light sources are all laser light sources is described; however, the technology is not limited thereto, and one or more of the plurality of kinds of light sources may be laser light sources. In other words, a combination of a laser light source and any other light source (for example, an LED) may be included in the light source section.

Further, in the above-described embodiments and the like, the case where the light modulation device is the reflective liquid crystal device or the DMD is described as an example; however, the technology is not limited thereto. Alternatively, the light modulation device may be, for example, a transmissive liquid crystal device.

In addition, in the above-described embodiments and the like, the case where three kinds of light sources emitting light of different wavelengths are used is described; however, for example, one kind, two kinds, or four or more kinds of light sources may be used.

Moreover, in the above-described embodiments and the like, respective components (optical systems) of the illumination device and the display unit are specifically described; however, it is not necessary to include all of the components, or other components may be further included. More specifically, for example, dichroic mirrors may be included instead of the dichroic prisms 131 and 132. Likewise, an optical member (for example, a rod integrator) other than the fly-eye lens 14 described in the above-described embodiments and the like may be used as the “uniformizing optical system” in the disclosure.

Further, in the above-described embodiments and the like, the projection display unit configured through including the projection optical system (the projection lens) which projects light modulated by the light modulation device onto the screen is described; however, the technology is also applicable to a direct-view display unit and the like.

It is to be noted that the technology may have the following configurations.

(1) A display unit including:

a light source section including a laser light source;

a light modulation device modulating light emitted from the light source section, based on an image signal; and

a polarization control device disposed on an optical path of laser light emitted from the laser light source, and controlling a polarization state of light incident thereon to emit outgoing light having two or more kinds of polarization states.

(2) A display unit according to claim (1), in which

an exit surface where the outgoing light exits of the polarization control device is divided into a plurality of sub-regions, and

the outgoing light of the two or more kinds of polarization states separately exits from the plurality of sub-regions.

(3) The display unit according to (2), in which the plurality of sub-regions are two-dimensionally or one-dimensionally arranged in the exit surface.

(4) The display unit according to (2) or (3), in which the outgoing light from the polarization control device has both one kind or a plurality of kinds of linear polarization states and one kind or a plurality of kinds of circular polarization states.

(5) The display unit according to (1), in which

the polarization control device includes a plurality of kinds of optical devices laminated along the optical path of the laser light, and

the outgoing light of the two or more kinds of polarization states separately exits from the plurality of kinds of optical devices.

(6) The display unit according to any one of (1) to (5), further including a projection optical system projecting light modulated by the light modulation device onto a projection surface.

(7) The display unit according to (6), in which the polarization control device is disposed in proximity to an entrance pupil position or an exit pupil position in the projection optical system.

(8) The display unit according to (6) or (7), in which

the projection optical system includes an aperture, and

the polarization control device is disposed in proximity to the aperture.

(9) The display unit according to any one of (6) to (8), in which

a polarizing beam splitter is disposed on an optical path between the light modulation device and the projection optical system, and

the polarization control device is disposed on a side closer to the projection optical system of the polarizing beam splitter.

(10) The display unit according to (9), in which the light modulation device is a liquid crystal device.

(11) The display unit according to any one of (1) to (8), in which

an uniformizing optical system is disposed on an optical path between the light source section and the light modulation device, and

the polarization control device is disposed on a side closer to the light modulation device of the uniformizing optical system.

(12) The display unit according to (11), in which the light modulation device is a digital mirror device (DMD).

(13) The display unit according to any one of (1) to (12), in which the light source section includes three kinds of light sources emitting red light, green light, and blue light.

(14) The display unit according to (13), in which one or more of the three kinds of light sources are the laser light sources.

(15) An illumination device including:

a light source section including a laser light source; and

a polarization control device disposed on an optical path of laser light emitted from the laser light source, and controlling a polarization state of light incident thereon to emit outgoing light having two or more kinds of polarization states.

It is to be noted that the technology may also have the following configurations.

(1) An illumination device comprising:

a laser light source; and

a polarization control device configured to control a polarization state of laser light emitted thereon from the laser light source, and to output light having at least two different polarization states.

(2) The illumination device according to (1), wherein the polarization control device includes a polarization control region that includes a plurality of sub-regions that are two dimensionally arranged in a matrix form, the sub-regions including a first sub-region having a first polarization state, and a second sub-region having a second polarization state.

(3) The illumination device according to (1), wherein the polarization control device includes a polarization control region that includes a plurality of sub-regions that are one dimensionally arranged, the sub-regions including a first sub-region having a first polarization state, and a second sub-region having a second polarization state.

(4) The illumination device according to (1), wherein the polarization control device includes a polarization control region that includes sub-regions having at least one kind of linear polarization state and at least one kind of circular polarizations state.

(5) The illumination device according to (1), wherein the polarization control device includes a polarization control region that includes sub-regions having a plurality of kinds of linear polarization states.

(6) The illumination device according to (4), wherein the polarization control device includes a polarization control region that includes sub-regions having a plurality of kinds of linear polarization states and a plurality of kinds of circular polarization states.

(7) The illumination device according to (6), wherein the sub-regions include at least one sub-region configured to change a polarization state of incident light in a linear polarization state with a polarization axis along an X-axis direction of the polarization control region to outgoing light having one of:

(a) a counterclockwise circular polarization state when viewed from an exit surface of the polarization control region;

(b) a linear polarization state with a polarization axis along an upper-left oblique direction when viewed from the exit surface;

(c) a clockwise circular polarization state when viewed from the exit surface; and

(d) a linear polarization state with a polarization axis along an upper-right oblique direction when viewed from the exit surface. (8) The illumination device according to (2), wherein the sub-regions are sized and arranged to reduce an appearance of a speckle pattern when the output light is projected onto a diffusing surface.

(9) The illumination device according to (1), wherein the laser light source includes a combination of light from a red laser light source, a green laser light source, and a blue laser light source.

(10) The illumination device according to (9), wherein the laser light source further includes a plurality of dichroic prisms configured to combine the red, green and blue laser light from the respective laser light sources.

(11) The illumination device according to (9), wherein the laser light source further includes a uniformizing optical system configured to uniformize an in-plane intensity distribution of the combined laser light.

(12) The illumination device according to (11), wherein the uniformizing optical system includes a fly-eye lens.

(13) A display unit comprising:

a laser light source;

a light modulation device configured to modulate laser light emitted from the laser light source; and

a polarization control device configured to control a polarization state of the modulated laser light emitted thereon, and to output light having at least two different polarization states.

(14) The display unit according to (13), wherein the light modulation device is configured to reflect light emitting from the laser light source, and to modulate the light based on an image signal supplied from a display control system.

(15) The display unit according to (13), wherein the light modulation device is selected from the group consisting of a reflective liquid crystal device, a transmissive liquid crystal device, and a digital mirror device.

(16) The display unit according to (13), further comprising a polarization beam splitter provided in a path of the emitted laser light and provided between the polarization control device and the light modulation device.

(17) The display unit according to (13), further comprising a mirror plate positioned between the light modulation device and the polarization control device, wherein the polarization control device is positioned between the laser light source and the mirror plate.

(18) The display unit according to (17), wherein the light modulation device is a digital mirror device.

(19) An illumination device comprising:

a laser light source; and

a polarization control region including a first sub-region having a first polarization state, and a second sub-region having a second polarization state.

(20) The illumination device according to (19), wherein the polarization control region includes a plurality of sub-regions that are two dimensionally arranged in a matrix form, the sub-regions including the first sub-region and the second sub-region.

(21) The illumination device according to (19), wherein the polarization control region includes a plurality of sub-regions that are one dimensionally arranged, the sub-regions including the first sub-region and the second sub-region.

(22) The illumination device according to (19), wherein the polarization control region includes sub-regions having at least one kind of linear polarization state and at least one kind of circular polarizations state.

(23) The illumination device according to (22), wherein the sub-regions include at least one sub-region configured to change a polarization state of incident light in a linear polarization state with a polarization axis along an X-axis direction of the polarization control region to outgoing light having one of:

(a) a counterclockwise circular polarization state when viewed from an exit surface of the polarization control region;

(b) a linear polarization state with a polarization axis along an upper-left oblique direction when viewed from the exit surface;

(c) a clockwise circular polarization state when viewed from the exit surface; and

(d) a linear polarization state with a polarization axis along an upper-right oblique direction when viewed from the exit surface.

(24) The illumination device according to (19), wherein the polarization control region includes sub-regions having a plurality of kinds of linear polarization states.

(25) The illumination device according to (19), wherein the polarization control region includes sub-regions having a plurality of kinds of linear polarization states and a plurality of kinds of circular polarization states.

(26) The illumination device according to (20), wherein the sub-regions are sized and arranged to reduce an appearance of a speckle pattern when the output light is projected onto a diffusing surface.

(27) The illumination device according to (19), wherein the laser light source includes a combination of light from a red laser light source, a green laser light source, and a blue laser light source.

(28) The illumination device according to (27), wherein the laser light source further includes a plurality of dichroic prisms configured to combine the red, green and blue laser light from the respective laser light sources.

(29) The illumination device according to (27), wherein the laser light source further includes a uniformizing optical system configured to uniformize an in-plane intensity distribution of the combined laser light.

(30) The illumination device according to (29), wherein the uniformizing optical system includes a fly-eye lens.

(31) A display unit comprising:

a laser light source;

a light modulation device configured to modulate laser light emitted from the laser light source; and

a polarization control region including a first sub-region having a first polarization state, and a second sub-region having a second polarization state.

(32) The display unit according to (31), wherein the light modulation device is configured to reflect light emitting from the laser light source, and to modulate the light based on an image signal supplied from a display control system.

(33) The display unit according to (31), wherein the light modulation device is selected from the group consisting of a reflective liquid crystal device, a transmissive liquid crystal device, and a digital mirror device.

(34) The display unit according to (31), further comprising a polarization beam splitter provided in a path of the emitted laser light and provided between the polarization control device and the light modulation device.

(35) The display unit according to (31), further comprising a mirror plate positioned between the light modulation device and the polarization control device, wherein the polarization control device is positioned between the laser light source and the mirror plate.

(36) The display unit according to (35), wherein the light modulation device is a digital mirror device.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The application is claimed as follows:

1. An illumination device comprising:
a laser light source; and
a polarization control device configured to control a polarization state of laser light emitted thereon from the laser light source, and to output light having at least two different polarization states.

2. The illumination device according to claim 1, wherein the polarization control device includes a polarization control region that includes a plurality of sub-regions that are two dimensionally arranged in a matrix form, the sub-regions including a first sub-region having a first polarization state, and a second sub-region having a second polarization state.

3. The illumination device according to claim 1, wherein the polarization control device includes a polarization control region that includes a plurality of sub-regions that are one dimensionally arranged, the sub-regions including a first sub-region having a first polarization state, and a second sub-region having a second polarization state.

4. The illumination device according to claim 1, wherein the polarization control device includes a polarization control region that includes sub-regions having at least one kind of linear polarization state and at least one kind of circular polarizations state.

5. The illumination device according to claim 1, wherein the polarization control device includes a polarization control region that includes sub-regions having a plurality of kinds of linear polarization states.

6. The illumination device according to claim 4, wherein the polarization control device includes a polarization control region that includes sub-regions having a plurality of kinds of linear polarization states and a plurality of kinds of circular polarization states.

7. The illumination device according to claim 6, wherein the sub-regions include at least one sub-region configured to change a polarization state of incident light in a linear polarization state with a polarization axis along an X-axis direction of the polarization control region to outgoing light having one of:
a counterclockwise circular polarization state when viewed from an exit surface of the polarization control region;
a linear polarization state with a polarization axis along an upper-left oblique direction when viewed from the exit surface;
a clockwise circular polarization state when viewed from the exit surface; and
a linear polarization state with a polarization axis along an upper-right oblique direction when viewed from the exit surface.

8. The illumination device according to claim 2, wherein the sub-regions are sized and arranged to reduce an appearance of a speckle pattern when the output light is projected onto a diffusing surface.

9. The illumination device according to claim 1, wherein the laser light source includes a combination of light from a red laser light source, a green laser light source, and a blue laser light source.

10. The illumination device according to claim 9, wherein the laser light source further includes a plurality of dichroic prisms configured to combine the red, green and blue laser light from the respective laser light sources.

11. The illumination device according to claim 9, wherein the laser light source further includes a uniformizing optical system configured to uniformize an in-plane intensity distribution of the combined laser light.

12. The illumination device according to claim 11, wherein the uniformizing optical system includes a fly-eye lens.

13. A display unit comprising:
a laser light source;
a light modulation device configured to modulate laser light emitted from the laser light source; and
a polarization control device configured to control a polarization state of the modulated laser light emitted thereon, and to output light having at least two different polarization states.

14. The display unit according to claim 13, wherein the light modulation device is configured to reflect light emitting from the laser light source, and to modulate the light based on an image signal supplied from a display control system.

15. The display unit according to claim 13, wherein the light modulation device is selected from the group consisting of a reflective liquid crystal device, a transmissive liquid crystal device, and a digital mirror device.

16. The display unit according to claim 13, further comprising a polarization beam splitter provided in a path of the emitted laser light and provided between the polarization control device and the light modulation device.

17. The display unit according to claim 13, further comprising a mirror plate positioned between the light modulation device and the polarization control device, wherein the polarization control device is positioned between the laser light source and the mirror plate.

18. The display unit according to claim 17, wherein the light modulation device is a digital mirror device.

19. An illumination device comprising:
a laser light source; and
a polarization control region including a first sub-region having a first polarization state, and a second sub-region having a second polarization state,
wherein the polarization control region includes a plurality of sub-regions that are two dimensionally arranged in a matrix form, the sub-regions including the first sub-region and the second sub-region, and
wherein the sub-regions are sized and arranged to reduce an appearance of a speckle pattern when the output light is projected onto a diffusing surface.
